(19) United States
(12) Patent Application Publication
(10) Pub. No.: US 2025/0179663 A1
(43) Pub. Date: Jun. 5, 2025

(54) PRODUCTION UNIT FOR GENERATING HYDROGEN

(71) Applicant: KEIL SOLAR BALLOON COMPANY GMBH, Groß-Zimmern (DE)

(72) Inventor: Peter KEIL, Darmstadt (DE)

(73) Assignee: KEIL SOLAR BALLOON COMPANY GMBH, Groß-Zimmern (DE)

(21) Appl. No.: 18/837,597

(22) PCT Filed: Feb. 7, 2023
(86) PCT No.: PCT/EP2023/053023

§ 371 Date: Aug. 10, 2024

(30) Foreign Application Priority Data
Feb. 10, 2022 (DE) 22156171.5

(51) Int. Cl. C25B 9/50; C01C 1/04; C25B 1/04; C25B 1/55

(52) U.S. Cl. CPC C25B 9/50; C01C 1/0447; C25B 1/04; C25B 1/55

(57) ABSTRACT

A production unit for the production of hydrogen or ammonia by electrolytic decomposition of water, with an electrolysis unit supplied with electrical energy by a photovoltaic unit and connected on the media side to a water storage tank and on the output side to a hydrogen tank, is intended to enable a particularly reliable and fluctuation-insensitive use of a regenerative energy source. For this purpose, the production unit is designed for floating operation and comprises a balloon envelope forming a buoyant body which can be filled with a buoyancy gas and which is provided with a support structure for the water storage unit, the electrolysis unit, the photovoltaic unit and the hydrogen storage unit.

### CROSS-REFERENCE TO RELATED APPLICATION

This application is a national phase of International Application No. PCT/EP2023/053023, filed Feb. 7, 2023, which is hereby incorporated by reference in its entirety.

### FIELD

This disclosure relates to a production unit for generating hydrogen by electro rolytic decomposition of water, with an electrolysis unit supplied with electrical energy by a photovoltaic unit. It further relates to a system for producing hydrogen with a plurality of such production units.

### BACKGROUND

In terms of sustainable energy concepts, the use of hydrogen as an energy carrier for later use as a fuel in mobile or stationary consumers has now become a highly regarded option. In such concepts, it is particularly desirable to produce hydrogen using renewable or “green” energy sources by electrolytically splitting water into hydrogen on the one hand and oxygen on the other. To this end, the water is split into the aforementioned components in an electrolysis unit, for example a membrane electrolyzer, by applying an electric voltage, for example across a membrane, and the associated ion migration. Such concepts are particularly environmentally friendly and ideally CO₂-neutral if the voltage required for electrolysis, i.e. the supply of electrical energy, is provided by a renewable energy source such as photovoltaics or wind energy.

An example of such a regeneratively powered electrolysis unit for hydrogen is described in DE 10 2010 011 407 A1.

However, what such systems have in common is that, precisely because they rely on regenerative energy sources to operate the electrolysis unit, they are subject to the usual strong fluctuations in the provision of the required energy, which are essentially inherent in all regenerative energy sources such as wind, water and sun. Without regard for possible system stresses due to the constantly changing load, accompanied by increased wear on the systems, this results in an undesirable limitation and restriction of the production rate or yield of hydrogen produced that can be achieved with such systems.

One objective of this disclosure is therefore to provide a production unit for the generation of hydrogen by electrolytic decomposition of water of the above-mentioned type at which enables particularly reliable and fluctuation-resistant utilization of the regenerative energy source.

### SUMMARY

In accordance with this disclosure, the above objective is achieved with a balloon envelope forming a buoyant body which can be filled with a buoyancy gas and which is provided with a support structure for the water storage unit, the electrolysis unit, the photovoltaic unit and the hydrogen storage unit.

This disclosure is based on the consideration that access to regenerative energy is particularly reliable and possible with little fluctuation if the respective energy converter is suitably positioned at a location with a reliable supply of the selected natural energy source. In the case of the solar radiation selected as the energy source, i.e. when using photovoltaics as an energy converter, this means that the energy converter should be positioned as high up as possible, i.e. in particular above half of the cloud cover, and also in regions with high intensity solar radiation. In order to take this into account, this disclosure provides for bundling the production unit for hydrogen production, including its essential components, in the form of a mobile package and arranging it on a common carrier structure, by means of which the entire package or bundle can be moved in its entirety and brought to a selected position. In order to meet the intended height requirement, i.e. positioning preferably above the cloud cover, the package or bundle should also be designed to be suitable for hovering operation. For this purpose, it is desirable to connect the production unit to a buoyancy body filled with hydrogen and/or helium. This allows the entire production unit to float above the cloud cover during the production cycle. The production unit can therefore also be referred to as a “solar balloon”.

Advantageous embodiments are the subject of the subclaims.

The above-mentioned technical components, i.e. the electrolysis unit, the water storage unit and the photovoltaic unit, can, for example, be arranged on a common support structure that can be set into the desired floating position by means of the balloon envelope and the buoyancy gas contained therein. The support frame can be arranged more or less inside the balloon envelope so that a relatively compact design can be achieved. Helium or hydrogen is advantageously provided as the buoyancy gas, in particular with recourse to findings from airship construction. In addition to the chambers provided inside the balloon envelope for the buoyancy gas, in particular helium, a number of tanks or chambers for the hydrogen produced can also be provided inside the balloon envelope, so that the hydrogen produced can be used as an additional buoyancy gas to maintain the hovering propulsion.

A particularly compact and thus easy-to-handle design for said package or bundle can be achieved by advantageously arranging the water reservoir and/or the electrolysis unit inside the balloon envelope forming the buoyancy body.

The photovoltaic unit comprises a number of photovoltaic cells, which are preferably arranged on the outside of the balloon envelope.

According to one aspect of this disclosure, said production unit, or a plurality of such units, is used in a system for producing hydrogen, wherein the production units are advantageously positioned at a location with a high average solar radiation. A working height above the cloud cover, preferably up to 8000 m, is particularly preferred. It is also particularly preferable to set up the production operation of the described floating production units in the area of the terrestrial polar regions, i.e. in particular beyond the respective polar circles, as a continuous availability of sunlight is guaranteed in these regions in the respective selected season. It is particularly preferable for the positioning that the aforementioned production unit is exposed to full-time solar radiation at a working altitude of up to 8000 m with a maximum deviation from the North Pole of 1.8° on March 28 of a calendar year up to a deviation from the North Pole of 23.5° on June 21 up to a maximum deviation from the North Pole of 1.8° on September 14 on the polar day. Similarly, this applies from a deviation from the South Pole of 1.8° on September 28 to a deviation from the South Pole of 23.5° on December 21 to a deviation from the South Pole of 1.8° on March 14 for stationing near the South Pole during the winter half-year (in relation to the northern hemisphere). Such a system then advantageously comprises a number of further components, such as transport units, preferably designed as airships, which logistically connect the production units with a central collection point for produced water material and/or a central water reservoir.

With regard to the intended stationing at a working altitude of up to 8000 m in the area of the terrestrial polar regions, the production unit is advantageously designed to be suitable, in particular with regard to the design of the balloon envelope and the other components that are important for setting the hover operation. In particular, it is advantageously taken into account that an air density of 0.542 kg/m³ is to be expected in the ambient air at the desired working altitude. With a spherical design of the balloon envelope, a nominal output of the electrolyser (corresponding to the design output of the photovoltaic system) of 1 MW, an operating weight of the photovoltaic system of 20 t, an operating weight of the electrolyser of around 36 t and taking into account the required media supplies and stocks, a design volume of around 200,000 m³ is preferably provided for the balloon envelope. With a cylindrical design of the balloon envelope, a nominal output of the electrolyzer (corresponding to the design power output of the photovoltaic system) of 4 MW, an operating weight of the photovoltaic system of 80 t, an operating weight of the electrolyzer of about 144 t and taking into account the required media supplies and stocks, a design volume of about 800,000 m³ is preferably provided for the balloon envelope.

The system is thus designed for the production of hydrogen on the basis of floating factories formed by the aforementioned production units and, according to this disclosure, comprises as significant components a number of solar balloons of the type described above, each comprising a buoyancy body, a photovoltaic unit, an electrolyzer, technology and tank modules, a docking system, a drive unit as well as the associated supply structures: a water supply unit (Water Supply Unit), a number of hydrogen tankers for transporting the produced water substance and a number of hydrogen terminals to which the produced water substance can be delivered for the purpose of feeding it into the hydrogen network.

In a particularly preferred embodiment, which is regarded as independently inventive, the production unit is designed for highly efficient generation operation, preferably for “24/7” continuous operation over 24 hours a day, 7 days a week, depending on the stationing with respect to the earth's surface. In order to make this possible, the production unit according to one aspect of this disclosure is specifically designed to allow free alignment, so that the photovoltaic units can be aligned directly towards the sun at any time and thus for particularly high efficiency. Particularly advantageously, the production unit is therefore additionally designed to further facilitate free alignment, in the manner of a rotation of the entire unit about its center of gravity. For this purpose, according to one aspect of this disclosure, it is provided to enable positioning of the center of mass of the production unit at its center of buoyancy. If these centers of gravity coincide, rotation of the system about these centers of gravity is particularly simple and can be carried out with high system stability.

In order to make this possible, according to one aspect of this disclosure, means are provided for shifting the center of mass of the production unit in a targeted and controlled manner. For such a system for shifting the center of mass, which is considered to be inventive in its own right, according to one aspect of this disclosure the water reservoir can be formed by a plurality of tanks suitably distributed within the system and connected to each other on the media side. Preferably, one of the tanks is positioned in the center of the photovoltaic surface, with the other three being arranged in the area of the technology and tank modules. To balance the center of gravity, water can be distributed or pumped between the tanks in such a way that the center of gravity moves to the center of buoyancy and is held there.

Alternatively or additionally, suitably positionable, for example spindle-guided weights can also be provided, which can be suitably moved in the buoyancy body to balance the center of gravity.

According to one aspect of this disclosure, the production unit can also be designed to produce ammonia by synthesizing the hydrogen produced with, for example, nitrogen obtained from the ambient air. For this purpose, the production unit advantageously comprises a synthesis unit for producing ammonia (NH₃) by synthesizing hydrogen with nitrogen, preferably obtained from the ambient air.

The design of the water supply unit (“water supply unit”) and its conceptual connection to the described production system are considered to be constantly inventive. The design is based on the problem that for the intended production of hydrogen, a sufficiently measured supply of water should be provided as a starting material for the intended electrolysis. However, in view of the comparatively long production cycles of several months envisaged, during which the system should advantageously operate self-sufficiently, the provision of an overall sufficient water supply for this would probably mean too high a weight load, so that the envisaged floating operation could not easily be ensured. In order to take this into account, the water supply unit is designed for a pendulum operation, in which partial quantities of the water supply are supplied to the described production unit in recurring cycles.

The inventive use is made of the fact that the production operation of the described floating production units is intended to take place in the terrestrial polar regions, i.e. in areas with permanent ice cover. The water supply units are designed to obtain water by melting ice and then transporting it to the production units. For this purpose, the respective water supply unit is designed for a kind of shuttle operation between the terrestrial surface (for water extraction by melting ice) and the respective production unit at the intended working altitude of, for example, around 8000 m above sea level.

The advantages achieved with this disclosure consist in particular in the fact that the solar balloons and preferably their use in a combination system of several substructures enable particularly efficient production and provision of green hydrogen. The solar balloons enable the production of hydrogen by means of electrolysis in floating factories, which on the one hand can be positioned at a suitable height above the cloud cover and with their photovoltaic surfaces suitably aligned to face the sun's radiation, so that intensive solar radiation can be permanently on the photovoltaic surfaces and thus enormous production efficiency can be achieved in the generation of hydrogen in the electrolyzer. On the other hand, the solar balloons are also mobile units due to their design, which can change their location as required. In terms of geographical positioning in particular, it is possible to change between the poles every six months, for example, whereby a position at the North Pole can be selected in the summer half year (in relation to the northern hemisphere) and a position at the South Pole in the winter half year. This means that the solar balloons can be positioned continuously in the area of the so-called polar day (with its midnight sun), in which there is continuous solar radiation. This means that the photovoltaic modules can be operated continuously, guaranteeing uninterrupted production.

In particular, this disclosure makes it possible to provide a system for the production of ammonia or hydrogen based on floating factories whose center of mass and center of buoyancy are preferably identical or can be brought into overlap, and which can thus be freely aligned around the center of mass and thus towards the sun at any time. This system preferably comprises a number of solar balloons, each comprising a buoyancy body, photovoltaics, electrolyzer, modular, exchangeable technology and tank modules, docking system, drive, system for positioning the center of mass, as well as the associated supply structures: Water Supply Unit (water supply), NH₃/H₂ tanker (3) (in particular for the removal of production by means of exchangeable NH₃/H₂ tanks, preferably in the form of a returnable bottle system with weight equalization system through additional delivery of water) and NH₃/H₂ terminals (4) (for feeding into the NH₃/H₂ network by means of exchangeable NH₃/H₂ tanks in the form of a returnable bottle system).

In particular, this disclosure enables the provision of a combination system comprising four subordinate substructures for the production and provision of green ammonia/hydrogen. A particularly advantageous aspect of this disclosure lies in the orientation of the solar balloon “towards the sun”, i.e. in particular in such a way that the surface normal of the photovoltaic modules points towards the sun, and production at the poles in a “24/7” operating mode. A core idea of the solar balloon is the production of ammonia and/or hydrogen by means of electrolysis in floating factories that can be freely aligned with the sun and that can change their location every six months between the poles (summer half-year North Pole, winter half-year South Pole) to ensure uninterrupted production.

The Water Supply Unit (water supply unit) is used in particular to supply the solar balloon with water. Together with the solar balloon, it forms a self-sufficient production system that extracts water from the polar ice, which is used to produce hydrogen and oxygen. The NH₃/H₂ tankers and the NH₃/H₂ terminals are responsible for transportation and supply to the respective NH₃/H₂ networks.

### BRIEF DESCRIPTION OF THE DRAWINGS

Examples of embodiments of this disclosure are explained in more detail with reference to the drawings, in which:

FIG. 1 shows a floating production unit for generating hydrogen (“solar balloon”) in partial section,

FIG. 2 shows an alternative embodiment of the floating production unit as shown in FIG. 1,

FIG. 3 shows a top view of the production unit as shown in FIG. 1 and FIG. 2,

FIG. 4 shows another alternative embodiment of the floating production unit as shown in FIG. 1 in partial section,

FIG. 5 shows the floating production unit as shown in FIG. 4 in plan view,

FIG. 6 is a sketch of a number of different orientations of the production unit as shown in FIG. 1,

FIG. 7 shows the technical module in the version with a plurality of water tanks in plan view in a variant with three water tanks (FIG. 7a) and a variant with twelve water tanks (FIG. 7b),

FIG. 8 shows a production system with a plurality of production units of the type described above,

FIG. 9 shows a partial section of a water supply unit of the system shown in FIG. 8,

FIG. 10 shows an extension plunger of the water supply unit according to FIG. 9,

FIG. 11 is a sketch of the process sequence during operation of the water supply unit as shown in FIG. 9,

FIG. 12 is a side view of a hydrogen tanker of the system shown in FIG. 8,

FIG. 13 shows a docking or connection system for the above-mentioned components in section,

FIG. 14 is a perspective view of the base plates of the components of the docking or connection system shown in FIG. 13,

FIG. 15 shows a coupling system for connecting the above-mentioned components to each other, and

FIG. 16 shows an outer ring of the coupling system according to FIG. 15 in plan view. Identical parts are marked with the same reference signs in all figures.

### DETAILED DESCRIPTION

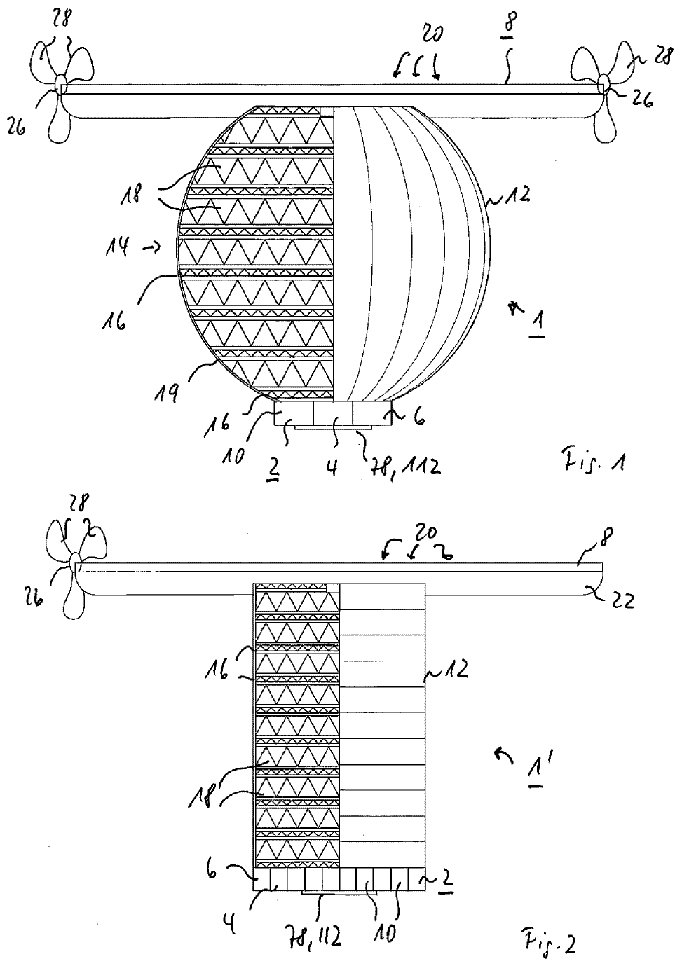

The production unit 1 according to FIG. 1 is designed for reliable and highly efficient production of hydrogen by electrolytic decomposition of water using a regenerative energy source, namely irradiated sunlight. Additionally or alternatively, the production unit 1 can also be designed to produce ammonia (NH₃) from the green hydrogen produced, in particular by synthesizing it with nitrogen obtained from the ambient air. It comprises an electrolysis unit 4 positioned in a technology module 2, which is intended for the electrolytic decomposition of water stored in a water reservoir 6 connected on the media side to the electrolysis unit 4 and also positioned in the technology module 2. To supply the electrolysis unit 4 with electricity, it is connected to a photovoltaic unit 8, which generates the required electricity from the incident sunlight. Furthermore, the production unit 1 comprises a hydrogen storage unit 10, also positioned in the technology module 2, for the hydrogen produced and, depending on the intended use, a synthesis unit 11 for synthesizing ammonia.

In order to enable access to the sunlight intended as a regenerative energy source in a particularly reliable and low-fluctuation manner, the production unit 1 is intended and designed to be positioned at a particularly high altitude, preferably above the cloud ceiling. For this purpose, the production unit 1 is designed to be suitable for hovering operation. The ensemble provided for hydrogen production, comprising the electrolysis unit 4, the water storage unit 6, the photovoltaic unit 8 and the hydrogen storage unit 10 as essential components for this purpose, is arranged on a balloon envelope 12 forming a support structure, i.e. suitable platforms or support frames for the electrolysis unit 4, the water storage unit 6, the photovoltaic unit 8 and the hydrogen storage unit 10 are arranged on the balloon envelope 12. The balloon envelope 12 forms a buoyancy body 14 filled with a suitable buoyancy gas, for example helium. This basic construction, which is designed in the form of a bundle or packaging for the main components, allows the entire production unit 1 to float above the cloud ceiling during the production cycle. The production unit 1 is thus designed in the manner of a “solar balloon”.

Helium is preferably provided as the buoyancy gas; however, the hydrogen produced in the electrolysis unit 4 can also be used as a buoyancy agent if necessary.

Accordingly, the solar balloon formed by the production unit 1 fulfils the function of producing green hydrogen by means of electrolysis, fed by electricity from photovoltaics, and essentially corresponds to a buoyant body equipped with photovoltaics, electrolyzer, drive motors and tanks for water (H₂O), hydrogen (H₂) and oxygen (O₂). Alternatively, the production unit 1 can also be designed to produce “green ammonia”; in this case, the green hydrogen generated in the electrolysis unit 4 is reacted with nitrogen extracted from the ambient air and synthesized into ammonia.

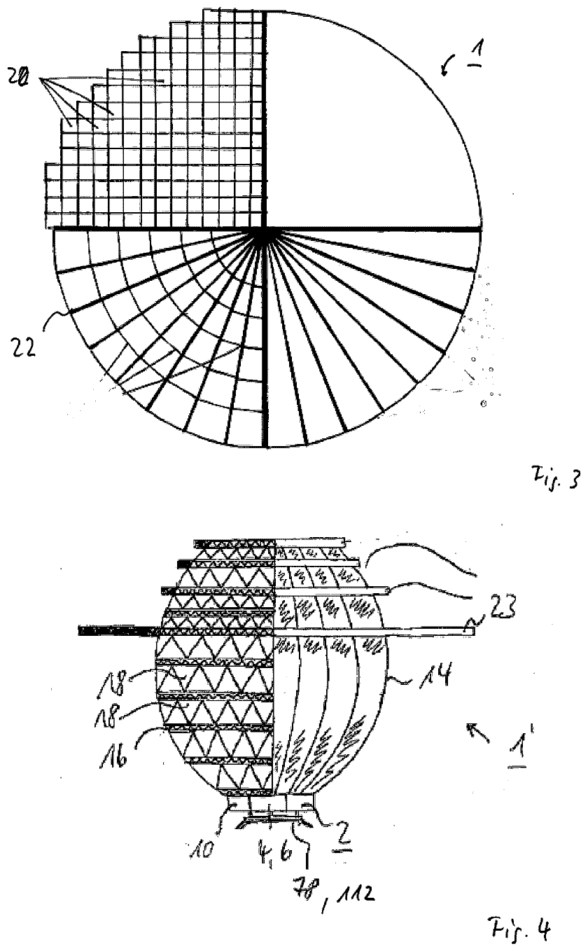

The buoyancy body 14 formed by the balloon envelope 12 serves, in addition to its actual function of providing the necessary buoyancy for hovering operation, as a structural base on or in which the other components are attached. The balloon envelope 12, which serves as the outer shell, is arranged on a lightweight support structure 16 with modular buoyancy gas containers 18. The lightweight support structure 16 also serves as a shaping element over which the outer skin or balloon envelope 12 is stretched. In the embodiment example shown in FIG. 1, a spherical shape is provided for the buoyancy body 14 in a particularly preferred embodiment, which is predetermined by correspondingly dimensioned disk or ring bodies 19 of the lightweight supporting structure 16. However, other shapes for the outer shell of the production unit 1 are also conceivable; for example, FIG. 2 shows a partial section of an alternatively designed production unit 1′ with an essentially cylindrical shape of the buoyancy body. In both variants, the modular buoyancy gas containers 18 are arranged inside the outer or balloon envelope 12, the buoyancy gas of which keeps the solar balloon at the desired height.

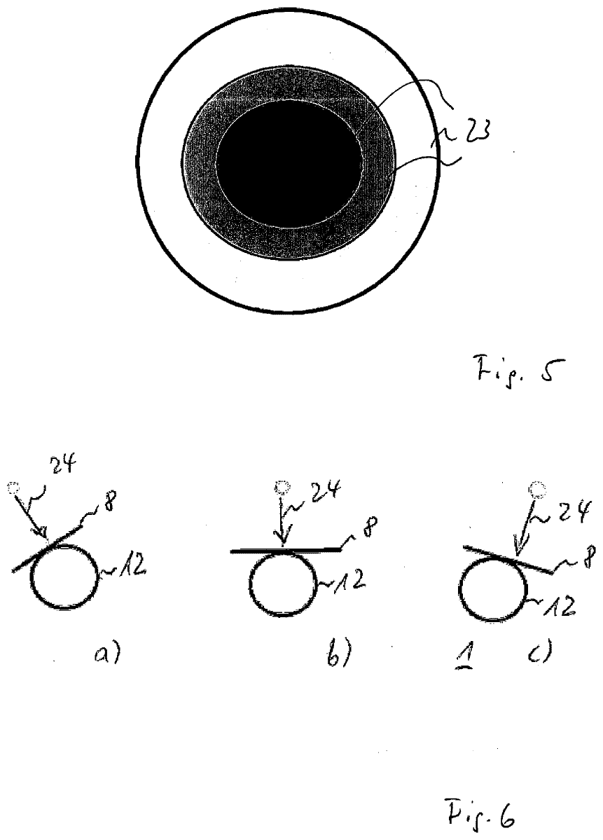

In the embodiment example, the photovoltaic unit 8 intended for electricity production is composed of a large number of lightweight photovoltaic elements 20, photovoltaic components or solar modules from conventional production, which are mounted on a common support structure 22, which in the embodiment example is designed in the form of a spider web. In the embodiment examples shown in FIGS. 1 and 2, the support structure 22 is designed in the form of an extended disk. The individual elements 20 mounted on the support structure 22 are clearly recognizable in the top view (with only half-covered support structure 22) as shown in FIG. 3. Alternatively, the support structure 22 could also be designed in the form of a sequence of stacked ring modules 23, adapted to the spherical design of the buoyancy body 14 in the example shown in FIG. 1, as shown in the partial section in FIG. 4 and in plan view in FIG. 5. For clarification, the ring modules 23 in FIG. 5 are shown in different shades of gray. The inner diameter of the ring modules 23 follows the outer diameter of the balloon envelope 12 at their positioning location. Furthermore, they are preferably dimensioned relative to each other in such a way that no mutual shading occurs when the light falls vertically, so that the efficiency of the system as a whole can be kept particularly high and, thanks to the free rotatability of the overall system around the center of gravity of the solar balloon, these can always be aligned in such a way that a perfect, vertical angle of incidence of the sunlight on the solar modules is achieved.

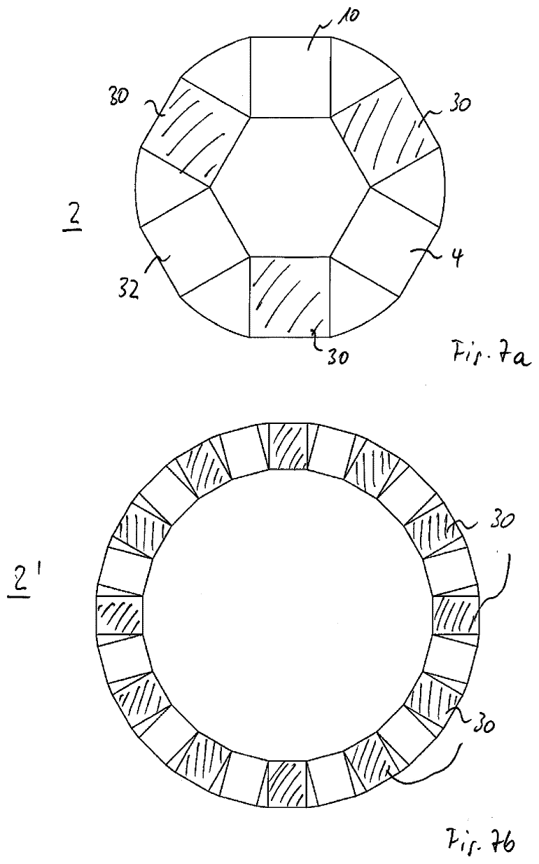

However, the embodiment shown in FIG. 1 with a disc-shaped support structure 22 is preferable to this design, as it can always be aligned around the centre of gravity of the solar balloon during operation in such a way that a perfect, vertical angle of incidence of the sun light on the solar modules is achieved, also due to the free rotatability of the overall system. This is shown in sketch form in the variants a), b), c) according to FIG. 6, whereby the line 24 symbolizes the incident solar radiation in each case.

The technology module(s) 2 serves to accommodate the technically necessary components, and accordingly, depending on the individual system design, different numbers of technology modules 2 with possibly different equipment can be provided. The technology modules 2 are, as can be seen in the embodiment example according to FIG. 1, attached to the support structure 16 regardless of their equipment and taking into account the properties of the photovoltaic unit 8 in such a way that the center of gravity of the solar balloon 1 is in its center or middle, so that it can rotate freely around its center. They thus serve as a counterweight to the photovoltaic unit 8, as the ability to reliably align the system “towards the sun” in all operating phases is particularly important in order to achieve a high degree of efficiency. In order to facilitate or even completely enable this, the production unit 1, 1′ according to one aspect of the invention is specifically designed so that the center of mass can be positioned in its center of buoyancy. If these centers of gravity coincide, it is particularly easy to rotate the system about these centers of gravity with a high degree of system stability. In order to make this possible, in the embodiment example shown, a plurality of water tanks 30 are provided as a means for the targeted displacement of the center of mass of the production unit 1, 1′ in an embodiment which is regarded as independently inventive, which together form the water reservoir 6. The water tanks 30 are suitably distributed within the system and connected to each other on the media side, so that water can be pumped between the individual tanks 30 as required and the center of gravity can thus be changed accordingly. According to a further development considered to be inventive, one of the tanks 30 is positioned in the center of the photovoltaic unit 8, with the other tanks 30 being arranged in the area of the technology module 2. To balance the center of gravity, water can be distributed or pumped between the tanks in such a way that the center of gravity moves to the center of buoyancy and is held there.

Viewed from above, the tanks 30 can be arranged within the technology module 2 alternating with other modules, for example the electrolysis unit 4, a control unit 32 or the like. This can be seen, for example, in the top view of the technology module 2 as shown in FIG. 7, where three tanks 30 are shown in the variant shown in FIG. 7a and twelve tanks 30 in the variant shown in FIG. 7b. Of course, any other number of tanks 30 is also conceivable, whereby the selection of the number and positioning of the tanks 30 is advantageously selected on the basis of other boundary conditions such as controllability of the setting of the center of gravity, specification of external boundary conditions and the like.

Alternatively or additionally, suitably positionable, for example spindle-guided weights can also be provided, which can be suitably displaced in the buoyancy body 12 to balance the center of gravity.

The electrolysis unit 4 is housed in one of the technology modules 2. It is supplied with water from the water tanks forming the water reservoir 6, which are also housed in technology modules 2, and produces “green” hydrogen with regard to the supply of electricity from the photovoltaic unit 8. The water tanks in turn are filled by means of an associated water supply, which is represented either by water extraction machines (e.g. condensers) housed in the technical area or preferably by the water supply unit described below.

To maneuver and position the buoyant body 14, a number of motors, in the embodiment example electric motors 26 with propellers 28, are arranged on it. These are powered by fuel cells, battery units or electricity from photovoltaics. Alternatively, a suitably selected number of hydrogen-powered combustion engines could be provided instead. Finally, the solar balloon is also equipped with a suitably designed control system for independent, autonomous movement.

The products from the water electrolysis in the production unit 1, 1′, hydrogen (H₂) and oxygen (O₂), can be transferred to the corresponding tanks via a system for high-pressure and/or liquid storage. For example, compression (e.g. 700 bar) or liquefaction can be provided upstream of for space-saving storage.

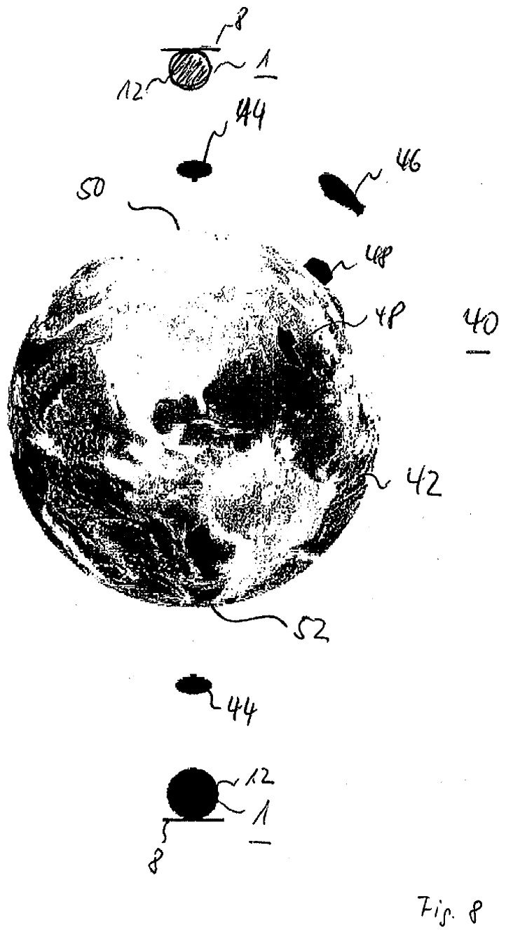

To further explain the mode of operation, a system 40 for producing hydrogen or ammonia with a plurality of production units 1 or 1′ of the type described above is shown in FIG. 8. The system 40 is designed for a globally organized mode of operation from and is therefore shown with respect to the global stationing of its components relative to the earth 42. In addition to a plurality of pro duction on units 1, 1′ of the type described above, of which only one is shown in the north and one in the south in FIG. 8 for the sake of clarity, the system 40 comprises a number of water supply units 44 provided for supplying the respective solar balloons with water, a number of hydrogen or ammonia tankers 46 and a number of hydrogen or ammonia terminals 48.

The tankers 46 and the terminals 48 are used to transport and transfer the hydrogen or ammonia produced in the production units 1, 1′ to the respective H₂ or NH₃ networks. In contrast, the water supply units 44 are used to supply water to the production units 1, 1′ so that sufficient basic material is kept available for hydrogen or ammonia production.

As shown schematically in FIG. 8, the production units 1, 1′ are stationed above the terrestrial north pole 50 (in relation to the northern hemisphere) in the summer half-year, in particular above the Arctic Circle, so that a continuous availability of sunlight is guaranteed. This allows the production units 1, 1′ to be continuously supplied with regenerative energy during this period and to produce hydrogen or ammonia. In the process, they are supplied with water via the water supply units 44, which they obtain by melting ice in the polar region, for example, in the form of a pendulum operation. The hydrogen or ammonia produced is then regularly transported from the production units 1, 1′ to the terminals 48 by the tankers 46, also in the form of a shuttle operation, from where it can be fed into the respective networks. This means that production can be carried out continuously in the area of the North Pole 50 in the period from April to August of each calendar year, for example.

In a subsequent phase, in conjunction with the end of summer in the northern hemisphere, the production units 1, 1′, possibly together with the other components, can be moved from their location in the area of the terrestrial north pole 50 to an alternative location in the area of the terrestrial south pole 52 in September of the respective calendar year, for example, where they carry out production during the winter half-year (in relation to the northern hemisphere). Thus, for example, production can be carried out continuously in the area of the south pole 52 in the period from October to March of each calendar year, as continuous solar radiation is available here during this time period. As the summer in the southern hemisphere comes to an end, for example in March, the production units 1, 1′ can then be relocated back to their northern location in the area of the north pole 50 and the annual production cycle can begin again. The “key dates” for the respective position changes from the northern to the southern polar region and vice versa are preferably selected and, according to one aspect of the invention, according to the criterion that solar radiation should be available as completely as possible over the entire day away, so that a 7-day/week 24-hour den/day operation is possible. This can be achieved, taking into account the terrestrial conditions, by placing the production units 1, 1′ at a working height above the cloud cover, in particular up to 8000 m, during the period from March 28 to September 14 of each calendar year in the area of the northern hemisphere. September of each calendar year in the area of the North Pole, with a maximum deviation from the North Pole of 1.8° on March 28 of a calendar year up to a maximum deviation from the North Pole of 23.5° on June 21 up to a maximum deviation from the North Pole of 1.8° on September 14, so that they are exposed to full-time solar radiation on the polar day. Similarly, this applies to a deviation from the South Pole of 1.8° on September 28 up to a deviation from the South Pole of 23.5° on December 21 up to a deviation from the South Pole of 1.8° on March 14 for stationing near the South Pole during the winter half-year (in relation to the northern hemi sphere).

In summary, the solar balloons 1, 1′ thus produce water continuously over the North Pole from around April to August, preferably from March 28 to September 14, with the water supply units 44 continuously supplying the solar balloons 1, 1′ with water. The tankers 46 fly the hydrogen continuously from the solar balloons 1, 1′ to the terminals 48. In a variation without tankers 46, the solar balloons 1, 1′ themselves fly the hydrogen or ammonia to the terminals every six months. In September, the solar balloons fly with the water supply units 44 from the North Pole 50 to the South Pole 52. At the South Pole 52, the solar balloons 1, 1′ produce hydrogen or ammonia continuously from approximately October to February, preferably from September 28 to March 14. In March, the solar balloons 1, 1′ fly with the water supply units 44 from the South Pole 52 back to the North Pole 50.

The production unit 1, 1′is designed to operate at a working height above the cloud cover so that production operations can be maintained as continuously as possible. For this purpose, the production unit 1, 1′is stationed at a working altitude of up to approximately 8000 m in the design example. The components, in particular the balloon envelope 12 and its load-bearing capacity, are dimensioned and designed accordingly. Among other things, it is taken into account that an air density of 0.542 kg/m³ is to be expected in the ambient air at the intended working height. With a spherical design of the balloon envelope, a nominal power of the electrolyzer (corresponding to the design power output of the photovoltaic system) of 1 MW, an operating weight of the photovoltaic system of 20 t, an operating weight of the electrolyzer of about 36 t and taking into account the required media supplies and stocks, a design volume of about 200,000 m³ is preferably provided for the balloon envelope at a flight altitude of about 8 km. More specifically, the following design parameters are preferably provided as examples for exemplary scenarios of a nominal output of the electrolysis unit of 1 MW or 4 MW:

### 1. Variant: Design 1 MW

| | |
|---|---|
| Output (MW) | 1 |
| Shape balloon envelope 12 | ball |
| Flight altitude (km) | 8 |
| Air density at an altitude of 8 km (kg/m³) | 0.542 |
| Buoyant gas | Helium/hydrogen |
| Photovoltaic unit 8: | |
| Output (MW) | 1 |
| Weight at 1MW output (t) | 20 |
| Area at 1MW output (m²) | 7000 |
| Electrolyzer 4: | |
| Power input (MW) | 1 |
| Output H₂ (kg/d) | 450 |
| Pressure H₂ (bar) | 30 |
| Weight electrolyzer (t) | 36 |
| Size | approx. 13.2 × 4.0 × |
| | 5.7 m |
| Hydrogen storage 10: | |
| Variant pressure tank 700bar: | |
| Specific weight H₂ at 700bar (kg/m³) | 40 |
| Daily volume with pressure tank storage (m³) | 11.25 |
| Hourly volume with pressure tank storage (m³) | 0.47 |
| Liquid storage variant: | |
| Specific weight H₂ at liquefaction (kg/m³) | 71 |
| Daily volume with liquefaction (m³) | 6.34 |
| Hourly volume with liquefaction (m³) | 0.26 |

In the variant intended for ammonia storage, dimensions and weights can be of a similar order of magnitude as for hydrogen, as the medium ammonia is comparatively heavier, but the tanks can be designed to be lighter in a similar ratio.

### Characteristic and Design Data for Solar Balloon 1

### Utilization Concept: Terminals in Australia (September-March) and Germany (March-September)

| | |
|---|---|
| Flight speed solar balloon 1 (km/h) | 60.00 |
| Flight distance north-south pole (km) | 20015.00 |
| Flight duration (h) | 333.58 |
| Active production time per half-year (h) | 4046.42 |
| (calculated from 365*24 h/2 - flight duration) | |
| Half-yearly yield H₂ per solar balloon (t) | 75.87 |
| Annual yield H₂ per solar balloon (t): | 151.74 |
| (calculated from production time * production capacity) | |
| Airspeed H₂ -tanker 46 (km/h) | 100.00 |
| Flight distance North Pole-Hamburg (km) | 4052.00 |
| Flight duration (h) | 40.52 |
| Flight distance South Pole-Melbourne (km) | 5800.00 |
| Flight duration (h) | 58.00 |

With a coverage of one H₂ tanker per solar balloon (1), the tank volume results from the longest flight duration*2+pick-up time at the terminal+loading time at the solar balloon (1) (=production time) multiplied by the hours volume of the H₂ production

| | |
|---|---|
| Estimated pick-up time at the terminal (h) | 12.00 |
| Estimated loading time on the solar balloon (h) | 12.00 |
| Production time (h): | |
| Longest flight time H₂ -tanker*2 + acceptance time + | 140.00 |
| loading time | |
| Tank volume at production time at 700 bar (m³) | 65.63 |
| Tank volume at production time liquefaction (m³) | 36.97 |
| Weight H₂ tank capacity, both solar balloon and H₂ | 2.63 |
| tanker (t) | |
| Weight electrolyzer (t) | 36.00 |
| Weight photovoltaic (t) | 20.00 |
| Buoyancy body estimate (t) | 50.00 |
| Weight solar balloon full tank (t) | 108.63 |
| Volume of buoyancy body at 8 km altitude | 200,415.13 |
| full tank (m₃) | |
| Diameter of sphere at 8km altitude | 72.61 |
| with full tank (m) | |

### Characteristics and Design Data for Hydrogen Tankers 46

| | |
|---|---|
| Airspeed H₂ -tanker (km/h) | 100.00 |
| Flight distance North Pole-Hamburg (km) | 4052.00 |
| Flight duration (h) | 40.52 |
| Flight distance South Pole-Melbourne (km) | 5800.00 |
| Flight duration (h) | 58.00 |
| Flight duration for one load/unload (h): | |
| Longest flight time*2 + pick-up time + loading time | 140.00 |
| Fuel bills see above | |
| Tank volume at production time at 700 bar (m³) | 65.63 |
| Tank volume at production time liquefaction (m³) | 36.97 |
| Weight H₂ -tank capacity, both solar balloon and hydrogen | |
| tanker (t) | 2.63 |
| Weight of buoyancy body estimate (t) | 5.00 |
| Weight full H₂ tanker (t) | 7.63 |
| Volume of buoyancy body at 8 km altitude | |
| with full tank (m³) | 14,068.27 |

### Characteristic and Design Data for Water Supply Unit 44

Must ascend 8 km from the ground to the solar balloon (1), extract and deliver water. With a production target of 450 kg H₂/day, 4050 kg/day of water is required Assumption:

| | |
|---|---|
| ascent + delivery + descent Duration (h) | 24.00 |
| Tank volume with 4050 kg water (m³) | 4.04 |
| Empty weight estimate buoyancy body + technology (t) | 7.50 |
| Weight of full water supply unit (t) | 11.54 |
| Volume of buoyancy body at 8 km altitude | 21,287.55 |
| with full tank (m³) | |

### 2. Variant: Design 4 MW

| | |
|---|---|
| Output (MW) | 4 |
| Shape of balloon envelope 12 | Cylinder |
| Flight altitude (km) | 8 |
| Air density at an altitude of 8 km (kg/m³) | 0.542 |
| Buoyant gas | Helium/hydrogen |
| Photovoltaic unit 8: | |
| Output (MW) | 4 |
| Weight at 1MW output (t) | 80 |
| Area with 1MW output (m²) | 28000 |
| Electrolyzer 4: | |
| Power input (MW) | 4 |
| Output H₂ (kg/d) | 1,800 |
| Pressure H₂ (bar) | 30 |
| Weight electrolyzer (t) | 144 |
| Size | 4x approx. 13.2 × |
| | 4.0 × 5.7 m |
| Hydrogen storage 10: | |
| Variant pressure tank 700bar: | |
| Specific weight H₂ at 700bar (kg/m³) | 40 |
| Daily volume with pressure tank storage (m³) | 45 |
| Hourly volume with pressure tank storage (m³) | 1.88 |
| Liquid storage variant: | |
| Specific weight H₂ at liquefaction (kg/m³) | 71 |
| Daily volume with liquefaction (m³) | 25.35 |
| Hourly volume with liquefaction (m³) | 1.06 |

In the variant intended for ammonia storage, dimensions and weights can be of a similar order of magnitude as for hydrogen, as the medium ammonia is comparatively heavier, but the tanks can be designed to be lighter in a similar ratio.

### Characteristic and Design Data for Solar Balloon 1

### Utilization Concept: Terminals in Australia (September-March) and Germany (March-September)

| | |
|---|---|
| Flight speed solar balloon (1) (km/h) | 60.00 |
| Flight distance north-south pole (km) | 20015.00 |
| Flight duration (h) | 333.58 |
| Active production time per half-year (h) | 4046.42 |
| (calculated from 365*24 h/2 - flight duration) | |
| Half-yearly yield H2 per solar balloon (t) | 303 |
| Annual yield H₂ per solar balloon (t): | 607 |
| (calculated from production time * production capacity) | |
| Airspeed H₂ -tanker (km/h) | 100.00 |
| Flight distance North Pole-Hamburg (km) | 4052.00 |
| Flight duration (h) | 40.52 |
| Flight distance South Pole-Melbourne (km) | 5800.00 |
| Flight duration (h) | 58.00 |

With a coverage of one H₂ tanker per solar balloon (1), the tank volume results from the longest flight duration*2+pick-up time at the terminal+loading time at the solar balloon (1) (=production time) multiplied by the hours volume of H₂ production

| | |
|---|---|
| Estimated pick-up time at the terminal (h) | 12.00 |
| Estimated loading time on the solar balloon (h) | 12.00 |
| Production time (h): | |
| Longest flight time H₂ -tanker*2 + acceptance time + | 140.00 |
| loading time | |
| Tank volume at production time at 700 bar (m³) | 262.5 |
| Tank volume at production time liquefaction (m³) | 148 |
| Weight H₂ tank capacity, both solar balloon and H₂ | 10.5 |
| tanker (t) | |
| Weight electrolyzer (t) | 144.00 |
| Weight photovoltaic (t) | 80.00 |
| Buoyancy body estimate (t) | 200.00 |
| Weight solar balloon (t) | 434.50 |
| Volume of buoyancy chamber at 8 km altitude (m³) | 801,660.52 |
| Diameter of sphere at 8km altitude (m) | 115.26 |

### Characteristics and Design Data for Hydrogen Tankers 46

| | |
|---|---|
| Airspeed H₂ -tanker (km/h) | 100.00 |
| Flight distance North Pole-Hamburg (km) | 4052.00 |
| Flight duration (h) | 40.52 |
| Flight distance South Pole-Melbourne (km) | 5800.00 |
| Flight duration (h) | 58.00 |
| Flight duration for one load/unload (h): | |
| Longest flight time*2 + pick-up time + loading time | 140.00 |
| Fuel bills see above | |
| Tank volume at production time at 700 bar (m³) | 262.50 |
| Tank volume at production time liquefaction (m³) | 147.89 |
| Weight H₂ -tank capacity, both solar balloon and hydrogen | |
| tanker (t) | 10.5 |
| Weight of buoyancy chamber and tanks Estimate (t) | 113.00 |
| Weight H₂ -tanker (t) | 123.50 |
| Volume of buoyancy chamber at 8 km altitude (m³) | 227,859.78 |

### Characteristic and Design Data of Water Supply Unit 44

Must ascend 8 km from the ground to the solar balloon (1), extract and deliver water. With a production target of 450 kg H₂/day, 4050 kg/day of water is required Assumption:

| | |
|---|---|
| ascent+delivery+descent Duration (h) | 24.00 |
| Tank volume with 4050 kg water (m³) | 16.15 |
| Empty weight estimate buoyancy body + technology (t) | 15 |
| Weight of full water supply unit (t) | 31.20 |
| Volume of buoyancy body at 8 km altitude | 57,564.58 |
| with full tank (m³) | |

Of course, a large number of other parameter combinations are also conceivable for the design of the system 40, whereby the values specified above can be used as orientation values. In the preferred range for the design of the power of 1 MW to 4 MW, a weight of for example 106 to 424 tons and a buoyancy volume of the buoyancy body 14 of for example 200,000 m³ to 800,000 m³ can prove to be suitable. Hydrogen or Helium is preferably provided as the lifting gas, the preferred flight altitude is up to about 8000 m, and the shape of the lifting body can be spherical to cylindrical.

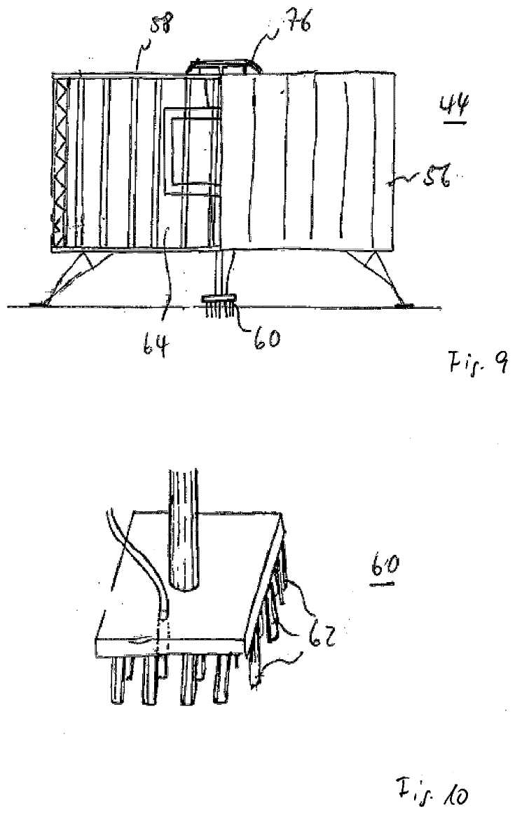

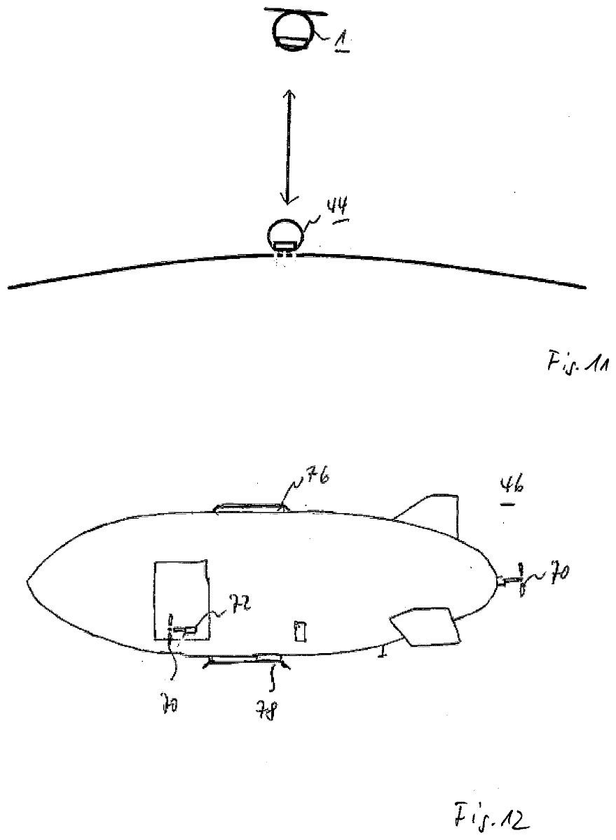

A partial sectional view of an embodiment of the water supply unit 44 is shown in FIG. 9. The water supply unit 44 has a base body 56, also designed as a buoyancy body, which is filled with helium and/or hydrogen as a buoyancy gas and is equipped with a photovoltaic surface 58 for energy supply. Furthermore, in the embodiment example shown, it comprises a heatable extension plunger 60 for water extraction, which is shown enlarged in FIG. 10. Stainless steel heating tubes 62 are arranged on the discharge plunger 60. These melt water from ice on the ground, which is conveyed by means of a pump to the water tanks 64 arranged in the interior of the base body 56 of the water supply unit 44. After filling the water tanks 64, the water supply unit 44 rises to the solar balloons 1, 1′ and delivers the water to them, as shown in the sketch of the process sequence in FIG. 11. The water supply unit 44 forms a self-sufficient production system together with the solar balloon 1, 1′. Alternatively, the solar balloon 1, 1′ could be supplied directly from the water content of the air, for example by condensation ration. In the embodiment example, the drive is provided by electricity from the photovoltaic surface 58 and/or electricity from a hydrogen-oxygen fuel cell or a battery unit, each of which can suitably drive an electric motor. ₂Just like the solar balloons 1, 1′, the water supply unit 44 is also equipped with tanks for water (H₂O) (not expressly shown) in addition to the tanks (64) for hydrogen (H₂) and oxygen (O₂).

A side view of an embodiment example of the tanker 46 is shown in FIG. 12. In terms of its structure, such a tanker in the embodiment example is essentially designed in the manner of a conventional airship. The tanker 46 should also be able to cover long distances, which is why it is manufactured in an aerodynamic form in the preferred embodiment shown in FIG. 12. Propellers 70 are provided as the drive, which can be powered, for example, by electric motors 72 with a hydrogen-oxygen fuel cell, a battery unit, a photovoltaic system or a combination of these options. Alternatively, a number of hydrogen engines could also be provided. The tanker 46 is also equipped with an unspecified control system for independent, autonomous movement and—as an independent aircraft—also with unspecified tanks for water (H₂O), for hydrogen (H₂) and for oxygen (O₂). Alternatively or additionally, depending on the design of the system, ammonia tanks can of course also be provided.

Reliable, problem-free media transfer between the individual components is of particular importance for reliable operation of the system 40, as the hydrogen or ammonia produced in the production units 1, 1′ must be transferred reliably and with as little loss as possible to the hydrogen/ammonia tankers 46 and from these to the respective terminals 48 after transportation. On the other hand, the water produced by the water supply units 44 must also be transferred to the production units 1, 1′.

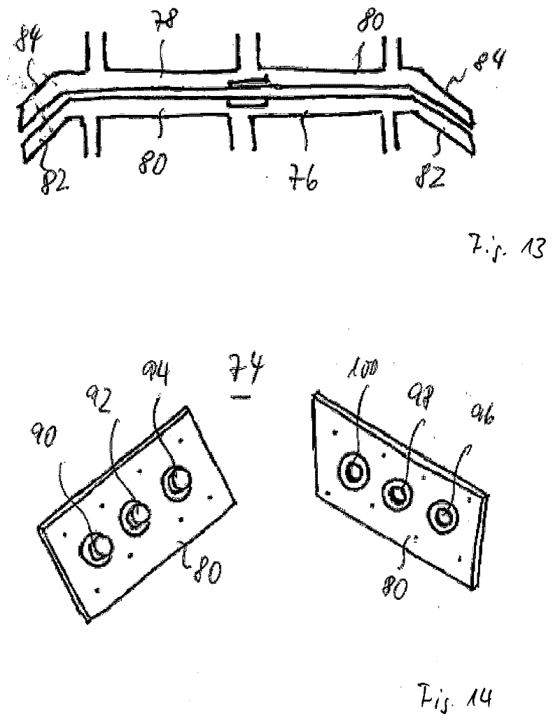

In order to make these transfer processes as reliable and low-loss as possible, the aforementioned components are equipped with a docking or connection system 74 at the relevant interfaces, which is considered to be independently inventive. This is designed to provide a reliable and stable detachable connection between two of the aforementioned components and to enable reliable media transfer between the components. To this end, the docking or connection system, as shown in section in FIG. 13, comprises two complementary, matched connecting elements 76, 78, of which the first connecting element 76 could be described as “male” and the second connecting element 78 as “female”. Both connecting elements 76, 78 each have a base plate 80, via which the mechanical connection to the other base plate 80 can be established in the manner of a surface contact. A circumferential collar 82, 84 is arranged on the side of the respective base plate 80, which in the case of the first, male connecting element 76 is inclined backwards, i.e. away from the other connecting element 78, by a predetermined angle, in the embodiment example 45°, and in the case of the second, female connecting element 78 is inclined forwards, i.e. towards the other connecting element 76, by the same predetermined angle. The two collars 82, 84 thus together form a guide pairing for the docking system 74, which ensures that when contact is made between the two base plates 80 with each other, they are correctly guided relative to each other and centered with respect to each other in accordance with the design. The two base plates 80 can then be fixed to each other by suitable means, for example a vacuum system or by means of magnetic elements, and maintained.

In FIG. 14, the base plates 80 of the male connecting element 76 and the female connecting element 78 are each shown in perspective view. It is clear from this that the base plates are provided with a number of media couplings that enable the safe transfer of the media that are important in the present case, namely hydrogen, oxygen and water. For this purpose, the base plate 80 assigned to the “male” connecting element 76 has a connecting plug 90 assigned to the medium hydrogen, a connecting plug 92 assigned to the medium oxygen and a connecting plug 94 assigned to the medium water. Complementary to these, the base plate 80 assigned to the “female” connecting element 78 has a connecting sleeve 96 assigned to the medium hydrogen, a connecting sleeve 98 assigned to the medium oxygen and a connecting sleeve 100 assigned to the medium water. These elements are provided with suitable self-closing valves. When a connection is established between the base plates 80, the corresponding media connections are also established by means of these plug-in connections so that media can be exchanged between the components.

Of course, an alternative or additional connector pairing assigned to the ammonia medium can also be provided if required.

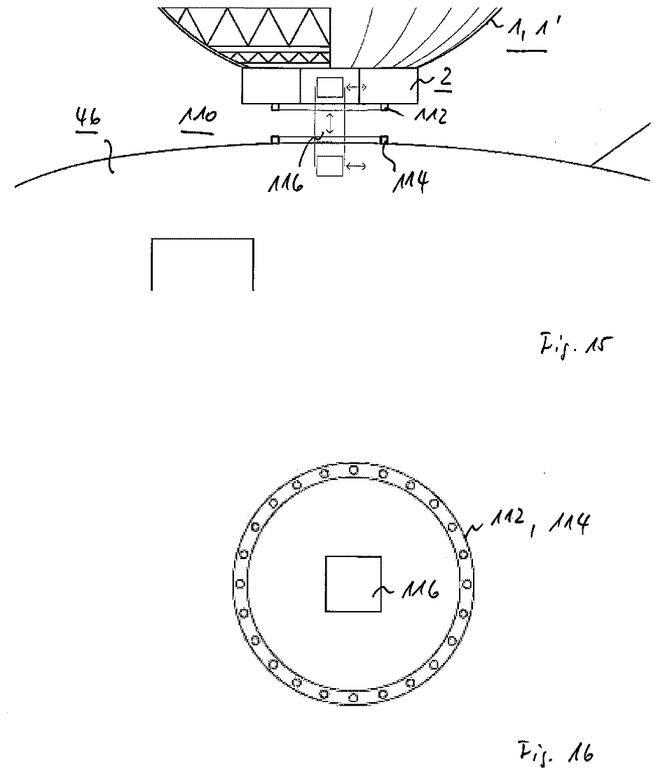

Alternatively or additionally, a coupling system 110 can also be provided for connecting or coupling several of the aforementioned components, as shown as an example in a sectional view in FIG. 15 for the connection of a production unit 1, 1′ with a tanker 46. The coupling system 110 is used, among other things, optionally in addition to a media transfer of the type described above, for the transfer of technology and tank modules between the system components solar balloon Water Supply Unit/tanker 46; it can thus be provided, for example, for the exchange or transfer of tank modules and/or for the exchange of technology modules 2 between any of the components mentioned.

As can be seen from the illustration in FIG. 15, the coupling system 110 comprises a pair of outer rings 112, 114 which can be coupled to one another, one of which is arranged on each of the components to be connected. As can be seen from the plan view according to FIG. 16, the pair of outer rings 112, 114 encloses an inner shaft 116, via which the said modules or other objects can be transferred between the coupled components. The coupling system 110 thus forms a ring-shaped docking mechanism. This has the shaft 116 in the middle, through which modules are transferred. The modules are isolated or separated from each other and are transported as a whole through the shaft 116.

The components of the system 40 are equipped with corresponding connecting elements 76, 78 and/or coupling systems 110 in an embodiment that is regarded as independently inventive, whereby all female connecting elements are designed to be compatible with all male connecting elements from, so that the components of the system 40 can be connected to one another as desired and in accordance with their purpose. In the design example shown, a distinction can be made between the “up” (=facing away from the earth and towards the sun) and “down” (=facing towards the earth) orientation due to the intended use of the components in floating operation. In order to enable system-wide compatibility of the components with each other, all components of the system 40 are equipped with a “female” connecting element 78 or outer ring 114 at their respective lower area and with a “male” connecting element 76 or outer ring 112 at their upper area. Of course, this could also be done the other way around.

### LIST OF REFERENCE SYMBOLS

1 Production unit
2 Technology module
4 Electrolysis unit
6 Water reservoir
8 Photovoltaic unit
10 Hydrogen storage
11 Synthesis unit
12 Balloon envelope
14 Buoyancy body
16 Lightweight support structure
18 Buoyant gas tank
19 Ring body
20 Photovoltaic element
22 Support structure
23 Ring modules
24 Line
26 Electric motor
28 Propeller
30 Water tank
40 System
42 Earth
44 Water supply unit
46 Hydrogen tanker
48 Hydrogen terminal
50 North Pole
52 South Pole
56 Base body
58 Photovoltaic area
60 Exit stamp
62 Heating pipe
64 Water tank
70 Screws
72 Electric motors
74 Docking system
76,78 Connecting element
80 Base plate
82,84 Collar
90-94 Connector plug
96-100 Connecting sleeve
110 Coupling system
112, 114 Outer ring
116 Shaft

1. A production unit for producing hydrogen by electrolytic decomposition of water, comprising: an electrolysis unit supplied with electrical energy by a photovoltaic unit, the electrolysis unit connected on a media side to a water storage tank and on an output side to a hydrogen storage tank, a balloon envelope forming a buoyancy body which can be filled with a buoyancy gas, which is provided with a support structure for the water storage unit, the electrolysis unit, the photovoltaic unit and the water storage unit, and means for displacing a center of mass of the production unit in order to enable the center of mass to be positioned at a center of buoyancy of the production unit.

2. The production unit according to claim 1, wherein at least one of the water storage unit, the electrolysis unit, and/or the hydrogen storage unit are arranged inside half of the balloon envelope forming the buoyancy body.

3. The production unit according to claim 1, wherein the photovoltaic unit comprises one or more photovoltaic elements arranged outside the balloon envelope.

4. The production unit according to claim 3, wherein the balloon envelope has a volume of approximately 200,000 m³ to approximately 800,000 m³.

5. The production unit according to claim 4, wherein the water reservoir is formed by a plurality of tanks connected to one another on the media side.

6. The production unit according to claim 1, further comprising one or more balancing weights arranged in the buoyancy body and adjustable in their position.

7. The production unit according to claim 1, further comprising a synthesis unit for producing ammonia (NH₃) by synthesizing hydrogen with nitrogen.

8. The method according to claim 9, further comprising positioning the production units at a working height of up to approximately 8,000 m above sea level during the production of the hydrogen or ammonia.

9. A method for producing hydrogen or ammonia with a plurality of production units according to claim 7, comprising positioning the center of mass of each production unit at its respective center of buoyancy during the production of the hydrogen or ammonia.

10. The method according to claim 8, wherein the production units are logistically connected to a central collection point for produced hydrogen via one or more transport units.

11. The method according to claim 8, wherein the production units are supplied with water by one or more water supply units, wherein each water supply unit comprises a base body configured as a buoyancy body and filled with helium and/or hydrogen as a buoyancy gas, and an extension plunger provided with a number of heating tubes for melting ice and receiving water.

12. The method according to claim 8, wherein hydrogen is produced in the production units.

13. The method according to claim 8, wherein ammonia is produced in the production units.

14. The production unit according to claim 6, wherein the position of the balancing weights is adjusted via a spindle drive.

15. The production unit according to claim 7, wherein nitrogen is obtained from ambient air.

16. A method for producing hydrogen with a plurality of production units according to claim 1, comprising positioning the center of mass of each production unit at its respective center of buoyancy during the production of the hydrogen.

17. The method according to claim 16, further comprising positioning the production units at a working height of up to approximately 8,000 m above sea level during the production of the hydrogen.
